(19) United States
(12) Patent Application Publication
(10) Pub. No.: US 2015/0361909 A1
(43) Pub. Date: Dec. 17, 2015

(54) VEHICLE

(71) Applicant: ISUZU MOTORS LIMITED, Tokyo (JP)

(72) Inventors: Shunsuke KUROKI, Fujisawa-shi (JP); Masahiro KAJIYAMA, Fujisawa-shi (JP); Teruaki KIMURA, Yokohama-shi (JP)

(73) Assignee: ISUZU MOTORS LIMITED, Tokyo (JP)

(21) Appl. No.: 14/655,002

(22) PCT Filed: Dec. 17, 2013
(86) PCT No.: PCT/JP2013/083746

§ 371 Date: Jun. 23, 2015

(30) Foreign Application Priority Data
Dec. 26, 2012 (JP) 2012-282786

(51) Int. Cl. F02D 41/04; B60T 7/04; F02D 29/02; B60T 17/22

(52) U.S. Cl. CPC F02D 41/045; B60T 17/22; B60T 7/042; F02D 29/02

(57) ABSTRACT

A vehicle includes an accelerator detection unit that detects an amount of depression of an accelerator pedal, brake detection units that detect depression of a footbrake pedal, vehicle speed detection units that detect a vehicle speed, and an output regulation unit that regulates an engine output when the following conditions are met: the amount of detected depression of the accelerator pedal is equal to or greater than a predetermined amount, depression of the footbrake pedal detected, and the detected vehicle speed is equal to or greater than a predetermined vehicle speed.

### TECHNICAL FIELD

The present invention relates to a vehicle that is equipped with a brake override system.

### BACKGROUND ART

Engine output control by depressing an accelerator pedal (gas pedal) is independently operated from deceleration by a footbrake pedal. Even if the accelerator pedal and the footbrake pedal are depressed at the same time, the engine output is not regulated immediately.

In order to deal with such fact, a vehicle is sometimes equipped with a so-called brake override system (brake prevailing system) that carries out the engine output control to give a priority to braking over accelerating when the accelerator pedal and the footbrake pedal are depressed at the same time (see, for example, Patent Literature 1).

### LISTING OF REFERENCES

### Patent Literatures

PATENT LITERATURE 1: Japanese Patent Application Laid-Open Publication No. 2012-72661

### SUMMARY OF THE INVENTION

Problems to be Solved by the Invention

However, the conventional brake override system immediately regulates the engine output as the accelerator pedal and the footbrake pedal are depressed at the same time. Thus, even when a vehicle driver intentionally depresses the accelerator pedal and the footbrake pedal at the same time, the engine output is regulated.

In view of such fact, an object of the present invention is to provide a vehicle that operates a brake override system appropriately depending upon given situations without sacrificing operability.

### Solutions to the Problems

In order to achieve the above-mentioned object, a vehicle of the present invention includes an accelerator detection unit that detects an amount of depressing of an accelerator pedal, a brake detection unit that detects whether a footbrake pedal is depressed, a vehicle speed detection unit that detects a vehicle speed, and an output regulation unit that limits or regulates an engine output when the following regulation conditions are satisfied: the amount of depressing of the accelerator pedal as detected by the accelerator detection unit configured to regulate the engine output is detected to be equal to or greater than a predetermined amount, depressing of the footbrake pedal is detected by the brake detection unit, and the vehicle speed detected by the vehicle speed detection unit is equal to or greater than a predetermined vehicle speed.

The vehicle may further include a counting unit for counting a time after the regulation conditions are satisfied. The output regulation unit may regulate the engine output when the time counted by the counting unit lasts for a predetermined time or more.

The output regulation unit may regulate the engine output to zero when the regulation conditions are satisfied.

The brake detection unit may have a first brake switch and a second brake switch for indicating whether or not the footbrake pedal is depressed. The vehicle may further include a deceleration detection unit for detecting deceleration of the vehicle speed, and a switch failure detection unit for determining that the first brake switch or the second brake switch has failed, when the deceleration of the vehicle speed detected by the deceleration detection unit is equal to or greater than predetermined deceleration of the vehicle speed, and the first brake switch or the second brake switch does not indicate that the footbrake pedal is depressed. The output regulation unit may be configured to prohibit regulation on the engine output when the switch failure detection unit determines that the first brake switch or the second brake switch has failed.

The brake detection unit may have a first brake switch and a second brake switch for indicating whether or not the footbrake pedal is depressed. The vehicle may further include a switch failure detection unit for determining that the first brake switch or the second brake switch has failed when the amount of depressing of the accelerator pedal detected by the accelerator detection unit is detected to be equal to or greater than a predetermined amount, the vehicle speed detected by the vehicle speed detection unit is equal to or greater than a predetermined vehicle speed, and the first brake switch or the second brake switch does not indicate that the footbrake pedal is not depressed. The output regulation unit may be configured to prohibit regulation on the engine output when the switch failure detection unit determines that the first brake switch or the second brake switch has failed.

### Advantages Of The Invention

The present invention has an advantage that it is possible to operate a brake override system appropriately depending upon given situations without sacrificing operability.

### BRIEF DESCRIPTION OF THE DRAWINGS

FIG. 1 illustrates a schematic configuration of a vehicle according to one embodiment of the present invention.

FIG. 2 illustrates a timing chart of engine output regulation.

FIG. 3 illustrates how the engine output regulation proceeds.

FIG. 4 is a flowchart of the engine output regulation.

FIG. 5 is a flowchart of switch failure detection.

FIG. 6 is another flowchart of switch failure detection.

### MODE FOR CARRYING OUT THE INVENTION

Now, a preferred embodiment of the present invention will be described with reference to the accompanying drawings.

It should be noted that in the drawings the “switch failure” is shortened to “SW Failure,” the “first brake switch” is shortened to “Brake SW1,” the “second brake switch” is shortened to “Brake SW2,” the “first vehicle speed” is shortened to “Vehicle Speed 1,” and the “second vehicle speed” is shortened to “Vehicle Speed 2.”

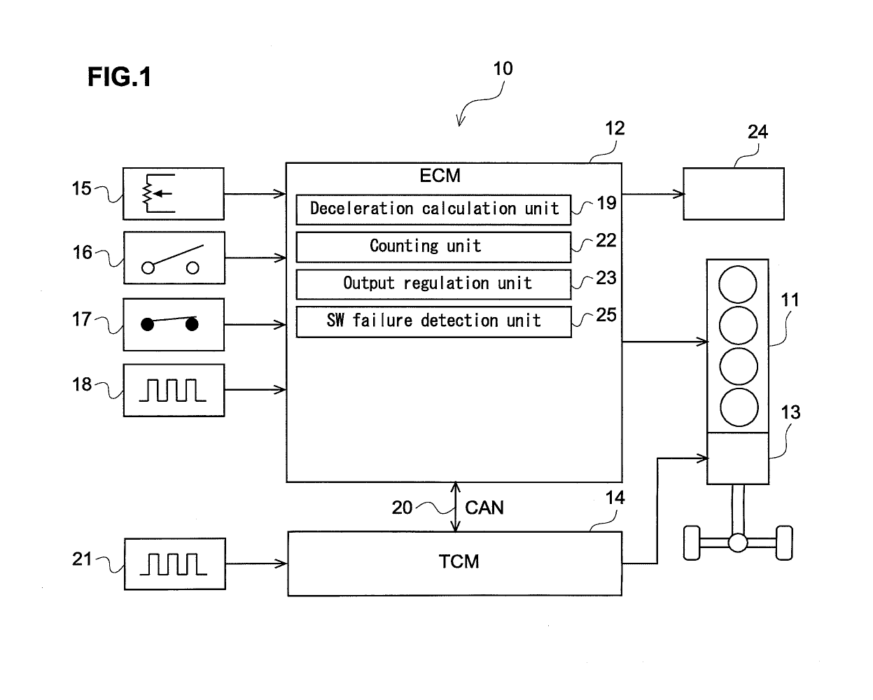

As shown in FIG. 1, a vehicle 10 of this embodiment has an engine control module (referred to as “ECM” hereinafter) 12, which is an electronic control unit to primarily control an engine 11, and a transmission control module (referred to as “TCM” hereinafter) 14, which is another electronic control unit to primarily control a transmission (speed change gear device) 13.

Various sensors and similar components such as an accelerator position sensor 15, a first brake switch 16 which is normally open, a second brake switch 17 which is normally closed, and a vehicle speed sensor 18 are connected to the ECM 12. The ECM 12 is configured to control the engine 11 and other parts in response to outputs from these sensors and components. The ECM 12 is connected to a CAN (control area network) 20, and can receive output signals from, for example, a countershaft rotation sensor 21 and other sensors, which are coupled to the TCM 14, via the CAN 20. It should be noted that in general the first brake switch 16, which is normally open, is used to operate a brake lamp and the like whereas the second brake switch 17, which is normally closed, is used to cancel automatic cruise control or for a similar purpose.

Various sensors and similar components such as the countershaft rotation sensor 21 are connected to the TCM 14. The TCM 14 is configured to control the transmission 13 and other parts in response to outputs from these sensors and components. The TCM 14 is coupled to the CAN 20, and can receive signals from the accelerator position sensor 15, the vehicle speed sensor 18 and other sensors, which are connected to the ECM 12, via the CAN 20.

The vehicle 10 of this embodiment also includes an accelerator detection unit, a brake detection unit, a vehicle speed detection unit, a counting unit, an output regulation unit, a deceleration detection unit, and a switch failure detection unit.

The accelerator detection unit detects an amount of depression of the accelerator pedal (referred to as “accelerator position” hereinafter). The accelerator position sensor 15 serves as the accelerator detection unit of the invention.

The brake detection unit detects an amount of depression of the brake pedal. The first brake switch 16 and the second brake switch 17 serve as the brake detection unit of the invention.

Specifically, the brake detection unit has the first brake switch 16, which is normally open, i.e., which is open (OFF) when the footbrake pedal is not depressed and which is closed (ON) when the footbrake pedal is depressed, and the second brake switch 17, which is normally closed, i.e., which is closed (ON) when the footbrake pedal is not depressed and which is open (OFF) when the footbrake pedal is depressed.

The vehicle speed detection unit detects a vehicle speed (traveling speed of the vehicle 10). The vehicle speed sensor 18 and the countershaft rotation sensor 21 serve as the vehicle speed detection unit of the invention.

The counting unit is configured to start counting time upon satisfaction of the regulation conditions, which will be described below. A counting unit 22 provided in the ECM 12 serves as the counting unit of the invention.

The output regulation unit regulates the engine output. An output regulation unit 23 provided in the ECM 12 serves as the output regulation unit of the invention.

The output regulation unit 23 controls the engine output to 0 (zero) when the following regulation conditions are met: it is detected that the accelerator position detected by the accelerator position sensor 15 is equal to or greater than a predetermined value (threshold value is for example 5%), a fact that the footbrake pedal is depressed is detected by the first brake switch 16 and the second brake switch 17, and the first vehicle speed detected by the vehicle speed sensor 18 or the second vehicle speed detected by the countershaft rotation sensor 21 is equal to or greater than a predetermined vehicle speed (threshold value is for example 10 km/h). The output regulation unit 23 also regulates the engine output when the time counted by the counting unit 22 lasts for a predetermined time (threshold value is for example 0.2-0.5 second).

One of the above-mentioned regulation conditions is that the first vehicle speed detected by the vehicle speed sensor 18 is equal to or greater than the predetermined vehicle speed. When the vehicle sensor 18 connected to the ECM 12 fails, for example, due to disconnection or the like and indicates that the first vehicle speed is zero, then the engine output regulation cannot be performed. To cope with such situation, the engine output is regulated to zero when the first vehicle speed detected by the vehicle speed sensor 18 connected to the ECM 12 is equal to or greater than the predetermined vehicle speed or when the second vehicle speed detected by the countershaft rotation sensor 21 connected to the TCM 14 is equal to or greater than the predetermined vehicle speed.

The deceleration detection unit (deceleration calculation unit 19 provided in the ECM 12) is configured to detect the deceleration of the (travelling) speed of the vehicle 10. The deceleration of the vehicle speed is calculated by differentiating the vehicle speed by time. The vehicle speed is calculated on the basis of the signal from the vehicle speed sensor 18.

The switch failure detection unit detects failure of the first brake switch 16 and the second brake switch 17 under the following two conditions. When the failure of the first brake switch 16 and the second brake switch 17 is detected by the switch failure detection unit, the output regulation unit 23 prohibits the regulation on the engine output, and causes a service vehicle soon lamp (referred to as “SVS lamp” hereinafter) 24 to light up. This prevents unintentional regulations on the engine output when the first brake switch 16 and the second brake switch 17 fail. The switch failure detection unit 25 provided in the ECM 12 serves as the switch failure detection unit of the invention.

The switch failure detection unit 25 determines that the first brake switch 16 or the second brake switch 17 has failed when the vehicle speed deceleration obtained by time-differentiating the vehicle speed calculated on the basis of the signal from the vehicle speed sensor 18 is equal to or greater than predetermined vehicle speed deceleration (threshold value is for example 0.2-0.4 G) and the first brake switch 16 or the second brake switch 17 does not indicate that the footbrake pedal is depressed (first condition). This is because it is assumed that the footbrake pedal is depressed if the vehicle speed deceleration calculated by time-differentiating the vehicle speed, which is calculated from the signal of the vehicle speed sensor 18, by time is equal to or greater than the predetermined vehicle speed deceleration. The switch failure detection unit 25 determines that the first brake switch 16 or the second brake switch 17 has failed when the first brake switch 16 or the second brake switch 17 continues to show no indication of a fact that the footbrake pedal is depressed, over a predetermined time (threshold value is for example 2-10 seconds).

The switch failure detection unit 25 determines that the first brake switch 16 or the second brake switch 17 has failed when it is detected that the accelerator position detected by the accelerator position sensor 15 is equal to or greater than a predetermined value (threshold value is for example 20%), the first vehicle speed detected by the vehicle speed sensor 18 is equal to or greater than a predetermined vehicle speed (threshold value is for example 10 km/h), and the first brake switch 16 or the second brake switch 17 does not indicate that the footbrake pedal is not depressed (second condition). This is because it is assumed that the footbrake pedal is not depressed if the accelerator position detected by the accelerator position sensor 15 is detected to be equal to or greater than the predetermined value and the first vehicle speed detected by the vehicle speed sensor 18 is equal to or greater than the predetermined vehicle speed. The switch failure detection unit 25 determines that the first brake switch 16 or the second brake switch 17 has failed when the first brake switch 16 or the second brake switch 17 continues to show no indication of a fact that the footbrake pedal is not depressed, over a predetermined time (threshold value is for example 2-10 seconds).

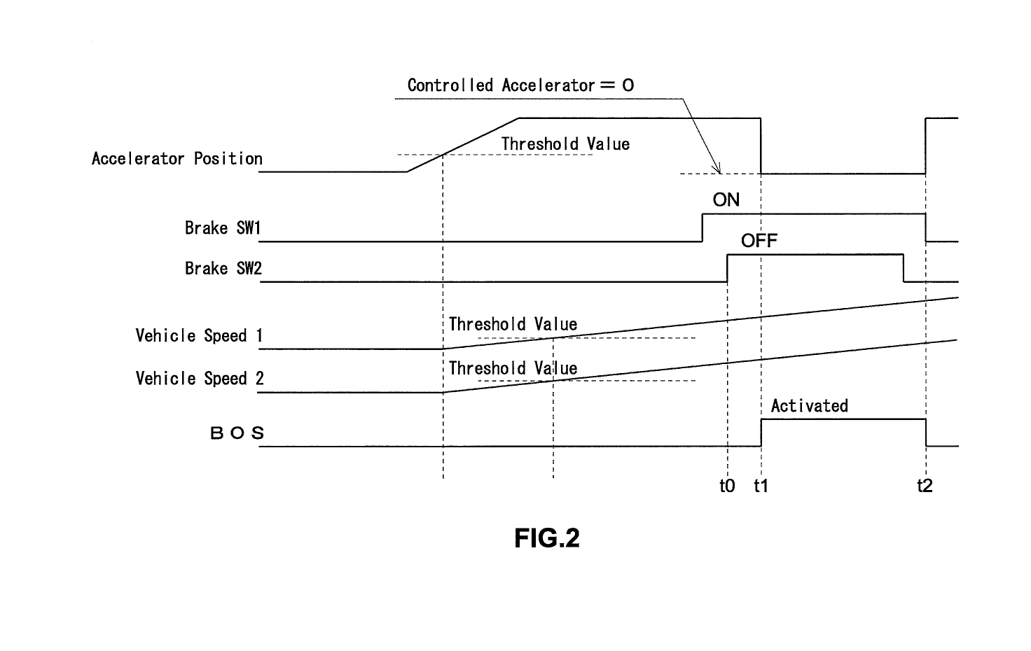

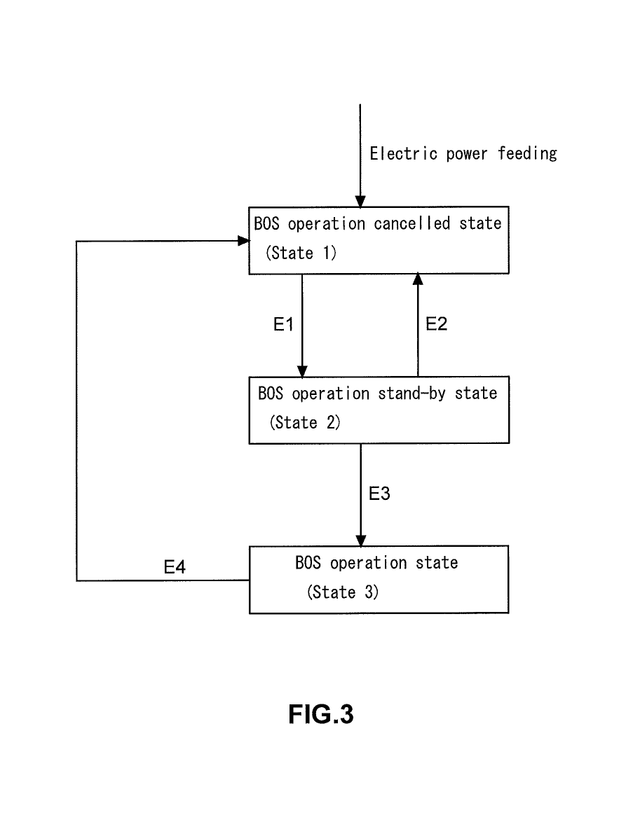

Referring now to FIGS. 2 and 3, the engine output regulation performed in the vehicle 10 of this embodiment, i.e., the operation of the brake override system (referred to as “BOS” hereinafter), will be described.

Upon feeding an electric power (upon turning on of an ignition key switch), the BOS is brought into an inoperative state, i.e., a BOS operation cancelled state (State 1 in FIG. 3). In the BOS operation cancelled state, the driver accelerator (i.e., accelerator position detected by the accelerator position sensor 15) is immediately entered to the controlled accelerator. In other words, the BOS is inoperative in the BOS operation cancelled state, and no engine output regulation is performed.

When the above-described regulation conditions are established during the BOS operation cancelled state, the BOS is brought into the BOS operation stand-by state (State 2 in FIG. 3) from the BOS operation cancelled state. The BOS operation stand-by state is also an inoperative state of the BOS (at the time t0 in FIG. 2, and the event E1 in FIG. 3). In the BOS operation stand-by state, the driver accelerator (i.e., accelerator position detected by the accelerator position sensor 15) is immediately entered to the controlled accelerator. In other words, similar to the BOS operation cancelled state, the BOS is inoperative in the BOS operation stand-by state, and no engine output regulation is performed.

In the BOS operation stand-by state, when the cancellation condition is met, i.e., when the first brake switch 16 and the second brake switch 17 detect the releasing of the footbrake pedal from a depressed position (first brake switch is turned off and the second brake switch is turned on) or the accelerator position detected by the accelerator position sensor 15 is less than a predetermined value (threshold value is for example 5%), then the BOS is returned to the BOS operation cancelled state from the BOS operation stand-by state (event E2 in FIG. 3).

During the BOS operation stand-by state, on the other hand, when the counter subtraction is made by the counting unit 22 and the counter value (count of the counter) becomes zero before the above-described cancellation condition is met, then the BOS is brought into the BOS operation state (State 3 in FIG. 3) from the BOS operation stand-by state (at time t1 in FIG. 2, and the event E3 in FIG. 3). In the BOS operation state, the controlled accelerator is set to zero regardless of the accelerator position detected by the accelerator position sensor 15. In other words, the BOS becomes operative (activated) in the BOS operation state, and the engine output regulation is performed.

When the above-described cancellation condition is established in the BOS operation state, the BOS is returned to the BOS operation cancelled state from the BOS operation state (at the time t2 in FIG. 2, and the event E4 in FIG. 3).

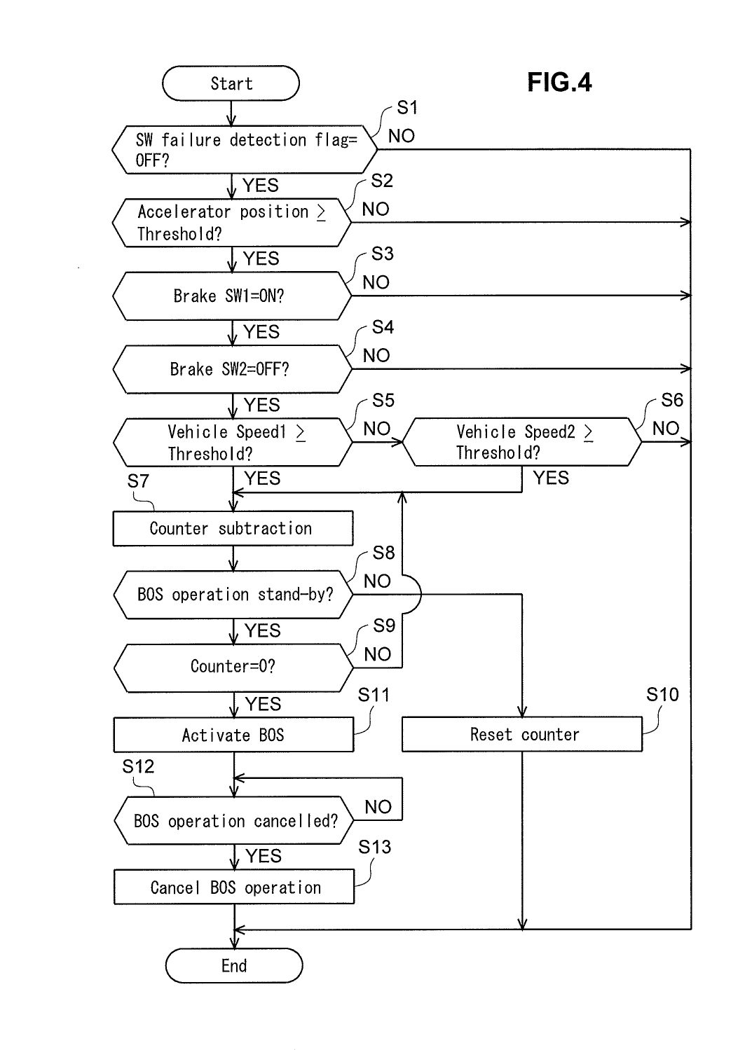

Referring now to FIG. 4, the control flow of the engine output regulation with the ECM 12 will be described. It should be noted that the control flow shown in FIG. 4 is repeatedly executed by the ECM 12 upon feeding of the electric power (turning on of the ignition key switch) until the electric power feeding stops (turning off of the ignition key switch).

As shown in FIG. 4, it is determined at Step 51 whether the switch failure detection flag is OFF or not. When the switch failure detection flag is OFF, the control proceeds to Step S2. When the switch failure detection flag is ON, the control returns to the start.

At Step S2, it is determined whether or not the accelerator position detected by the accelerator position sensor 15 is no less than a threshold value. When the accelerator position is no less than the threshold value, the control proceeds to Step S3. When the accelerator position is less than the threshold value, the control returns to the start.

At Step S3, it is determined whether or not the first brake switch 16 is in the ON state. When the first brake switch 16 is in the ON state, the control proceeds to Step S4. When the first brake switch 16 is in the OFF state, the control returns to the start.

At Step S4, it is determined whether or not the second brake switch 17 is in the OFF state. When the second brake switch 17 is in the OFF state, the control proceeds to Step S5. When the second brake switch 17 is in the ON state, the control returns to the start.

At Step S5, it is determined whether or not the first vehicle speed detected by the vehicle speed sensor 18 is no less than a threshold value. When the first vehicle speed is no less than the threshold value, the control proceeds to Step S7. When the first vehicle speed is less than the threshold value, the control proceeds to Step S6.

At Step S6, it is determined whether or not the second vehicle speed detected by the countershaft rotation 21 is no less than a threshold value. When the second vehicle speed is no less than the threshold value, the control proceeds to Step S7. When the second vehicle speed is less than the threshold value, the control returns to the start.

At Step S7, the counter subtraction is carried out. Then, the control proceeds to Step S8.

At Step S8, it is confirmed that the above-described cancellation condition is not met. When the cancellation condition is not met, the control proceeds to Step S9. When the cancellation condition is met, the counter is reset at Step S10, and the control returns to the start.

At Step S9, it is determined whether the value (count) of the counter is zero or not. When the counter value is zero, the control proceeds to Step S11. When the counter value is not zero, the control returns to Step S7.

At Step S11, the BOS is activated, and the control proceeds to Step S12.

At Step S12, it is confirmed that the above-described cancellation condition is met. When the cancellation condition is met, then the operation (activation) of the BOS is cancelled at Step S13, and the control returns to the start.

FIG. 4 is a flowchart showing the contents of FIG. 3, and is equivalent to FIG. 3.

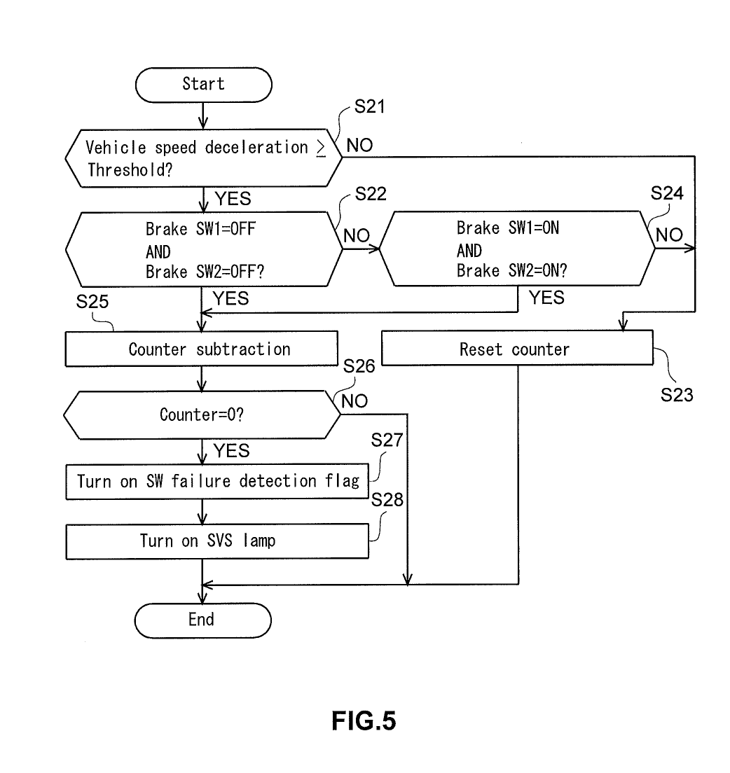

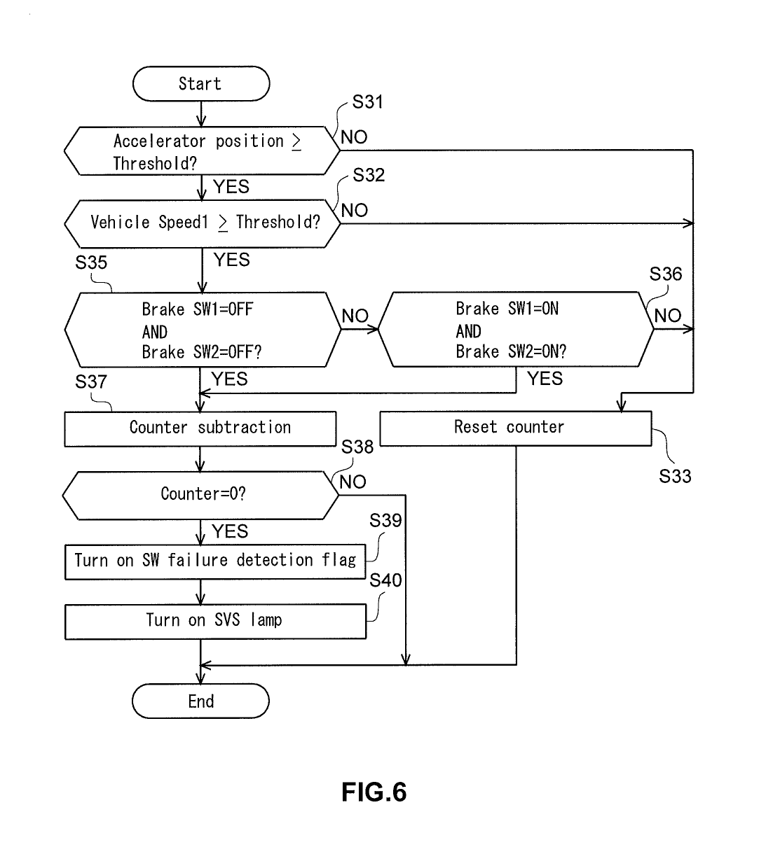

Referring now to FIGS. 5 and 6, the control flow of the switch failure detection with the ECM 12 will be described. It should be noted that the control flow shown in each of FIGS. 5 and 6 is repeatedly executed by the ECM 12 upon feeding of the electric power (turning on of the ignition key switch) until the electric power feeding stops (turning off of the ignition key switch).

As shown in FIG. 5, which is relevant to the above-described first condition, it is determined at Step S21 whether the vehicle speed deceleration, which is calculated by time-differentiating the vehicle speed, is no less than a threshold value. The vehicle speed is calculated from the signal of the vehicle speed sensor 18. When the vehicle speed deceleration is no less than the threshold value, the control proceeds to Step S22. When the vehicle speed deceleration is less than the threshold value, another counter, which is different from the counter used in determining whether the BOS should be operated or not, is reset at Step S23, and the control returns to the start.

At Step S22, it is determined whether or not the first brake switch 16 is in the OFF state and the second brake switch 17 is also in the OFF state. When the first brake switch 16 is in the OFF state and the second brake switch 17 is in the OFF state, then the control proceeds to Step S25. Otherwise, the control proceeds to Step S24.

At Step S24, it is determined whether or not the first brake switch 16 is in the ON state and the second brake switch 17 is also in the ON state. When the first brake switch 16 is in the ON state and the second brake switch 17 is in the ON state, then the control proceeds to Step S25. Otherwise, the counter is reset at Step S23, and the control returns to the start.

At Step S25, the counter subtraction is carried out. Then, the control proceeds to Step S26.

At Step S26, it is determined whether the value of the counter is zero or not. When the counter value is zero, the control proceeds to Step S27. When the counter value is not zero, the control returns to the start.

When it is determined at Step S26 that the counter value is zero, the switch failure detection flag is turned ON at Step S27, and the SVS lamp 24 is lit up at Step S28. Then, the control returns to the start. It should be noted that after the switch failure detection flag is turned ON at Step S27 and the SVS lamp 24 is lit up at Step S28, this control may no longer be executed.

On the other hand, as shown in FIG. 6, which is relevant to the above-described second condition, it is determined at Step S31 whether the accelerator position detected by the accelerator position sensor 15 is no less than a threshold value. When the accelerator position is no less than the threshold value, the control proceeds to Step S32. When the accelerator position is less than the threshold value, another counter, which is different from the counter used in determining whether the BOS should be operated or not, is reset at Step S33, and the control returns to the start.

It is determined at Step S32 whether the first vehicle speed detected by the vehicle speed sensor 18 is no less than a threshold value. When the first vehicle speed is no less than the threshold value, the control proceeds to Step S35. When the first vehicle speed is less than the threshold value, the control proceeds to Step S33.

The counter is reset at Step S33, and the control returns to the start.

At Step S35, it is determined whether or not the first brake switch 16 is in the OFF state and the second brake switch 17 is also in the OFF state. When the first brake switch 16 is in the OFF state and the second brake switch 17 is in the OFF state, then the control proceeds to Step S37. Otherwise, the control proceeds to Step S36.

At Step S36, it is determined whether or not the first brake switch 16 is in the ON state and the second brake switch 17 is also in the ON state. When the first brake switch 16 is in the ON state and the second brake switch 17 is in the ON state, then the control proceeds to Step S37. Otherwise, the counter is reset at Step S33, and the control returns to the start.

At Step S37, the counter subtraction is carried out. Then, the control proceeds to Step S38.

At Step S38, it is determined whether the counter value is zero or not. When the counter value is zero, the control proceeds to Step S39. When the counter value is not zero, the control returns to the start.

When it is determined at Step S38 that the counter value is zero, the switch failure detection flag is turned ON at Step S39, and the SVS lamp 24 is lit up at Step S40. Then, the control returns to the start. It should be noted that after the switch failure detection flag is turned ON at Step S39 and the SVS lamp 24 is lit up at Step S40, this control may no longer be executed.

Now, the operation and advantages of this embodiment will be described.

In the vehicle 10 of this embodiment, when the following three conditions are satisfied, i.e., it is detected that the accelerator position detected by the accelerator position sensor 15 is no smaller than the predetermined amount, a fact that the footbrake pedal is depressed is detected by the first brake switch 16 and the second brake switch 17, and it is determined that the first vehicle speed detected by the vehicle speed sensor 18 or the second vehicle speed detected by the countershaft rotation sensor 21 is no slower than the predetermined vehicle speed, then the engine output is regulated to zero. Accordingly, when the driver intentionally depresses the accelerator pedal and the footbrake pedal at the same time, such depressing of the pedals is tolerated as long as the vehicle speed is slower than the predetermined speed. Therefore, the operability of the vehicle 10 will not be adversely affected. In the vehicle 10 of this embodiment, when a state that the above-mentioned three conditions are satisfied lasts for a predetermined time, the engine output is regulated to zero. After the above-mentioned three conditions are satisfied and until the predetermined time elapses, the engine output regulation is not carried out and a gradual change is not made to the engine output. A state that the engine output is regulated to zero is immediately cancelled when the depressed accelerator pedal is released (i.e., upon returning of the accelerator pedal) or when the depressed footbrake pedal is released.

In summary, the vehicle 10 of this embodiment can operate the BOS appropriately depending upon given situations without sacrificing the operability.

Although the preferred embodiment of the present invention is described in the foregoing, the present invention is not limited to the above-described embodiment. The present invention may be practiced in various embodiments.

### REFERENCE NUMERALS AND SYMBOLS

10: Vehicle
15: Accelerator position sensor (accelerator detection unit)
16: First brake switch (brake detection unit)
17: Second brake switch (brake detection unit)
18: Vehicle speed sensor (vehicle speed detection unit)
19: Deceleration calculation unit (deceleration detection unit)
21: Countershaft rotation sensor (vehicle speed detection unit)
22: Counting unit (counting unit)
23: Output regulation unit (output regulation unit)
25: Switch failure detection unit (switch failure detection unit)

1. A vehicle comprising:
an accelerator detection unit for detecting an amount of depressing of an accelerator pedal;
a brake detection unit for detecting whether a footbrake pedal is depressed;
a vehicle speed detection unit for detecting a vehicle speed; and
an output regulation unit for regulating an engine output when regulation conditions are satisfied, the regulation conditions including the amount of depressing of the accelerator pedal detected by the accelerator detection unit being detected to be equal to or greater than a predetermined amount, depression of the footbrake pedal being detected by the brake detection unit, and the vehicle speed detected by the vehicle speed detection unit being equal to or greater than a predetermined vehicle speed.

2. The vehicle according to claim 1 further comprising a counting unit for counting a time after the regulation conditions are satisfied, and wherein the output regulation unit regulates the engine output when the time counted by the counting unit lasts for a predetermined time.

3. The vehicle according to claim 1, wherein the output regulation unit regulates the engine output to zero when the regulation conditions are satisfied.

4. The vehicle according to claim 1, wherein the brake detection unit includes a first brake switch and a second brake switch for indicating whether the footbrake pedal is depressed or not, and
the vehicle further comprises:
a deceleration detection unit for detecting deceleration of the vehicle speed; and
a switch failure detection unit for determining that the first brake switch or the second brake switch has failed, when the deceleration of the vehicle speed detected by the deceleration detection unit is equal to or greater than a predetermined deceleration of the vehicle speed, and the first brake switch or the second brake switch does not indicate that the footbrake pedal is depressed,
the output regulation unit being configured to prohibit regulation on the engine output when the switch failure detection unit determines the first brake switch or the second brake switch has failed.

5. The vehicle according to claim 1, wherein the brake detection unit includes a first brake switch and a second brake switch for indicating whether the footbrake pedal is depressed or not, and
the vehicle further comprises a switch failure detection unit for determining that the first brake switch or the second brake switch has failed when the amount of depressing of the accelerator pedal detected by the accelerator detection unit is detected to be equal to or greater than a predetermined amount, the vehicle speed detected by the vehicle speed detection unit is equal to or greater than a predetermined vehicle speed, and the first brake switch or the second brake switch does not indicate that the footbrake pedal is not depressed,
the output regulation unit being configured to prohibit regulation on the engine output when the switch failure detection unit determines that the first brake switch or the second brake switch has failed.

6. The vehicle according to claim 2, wherein the output regulation unit regulates the engine output to zero when the regulation conditions are satisfied.

7. The vehicle according to claim 2, wherein the brake detection unit includes a first brake switch and a second brake switch for indicating whether the footbrake pedal is depressed or not, and
the vehicle further comprises:
a deceleration detection unit for detecting deceleration of the vehicle speed; and
a switch failure detection unit for determining that the first brake switch or the second brake switch has failed, when the deceleration of the vehicle speed detected by the deceleration detection unit is equal to or greater than a predetermined deceleration of the vehicle speed, and the first brake switch or the second brake switch does not indicate that the footbrake pedal is depressed, the output regulation unit being configured to prohibit regulation on the engine output when the switch failure detection unit determines the first brake switch or the second brake switch has failed.

8. The vehicle according to claim 3, wherein the brake detection unit includes a first brake switch and a second brake switch for indicating whether the footbrake pedal is depressed or not, and
the vehicle further comprises:
a deceleration detection unit for detecting deceleration of the vehicle speed; and
a switch failure detection unit for determining that the first brake switch or the second brake switch has failed, when the deceleration of the vehicle speed detected by the deceleration detection unit is equal to or greater than a predetermined deceleration of the vehicle speed, and the first brake switch or the second brake switch does not indicate that the footbrake pedal is depressed, the output regulation unit being configured to prohibit regulation on the engine output when the switch failure detection unit determines the first brake switch or the second brake switch has failed.

9. The vehicle according to claim 2, wherein the brake detection unit includes a first brake switch and a second brake switch for indicating whether the footbrake pedal is depressed or not, and
the vehicle further comprises a switch failure detection unit for determining that the first brake switch or the second brake switch has failed when the amount of depressing of the accelerator pedal detected by the accelerator detection unit is detected to be equal to or greater than a predetermined amount, the vehicle speed detected by the vehicle speed detection unit is equal to or greater than a predetermined vehicle speed, and the first brake switch or the second brake switch does not indicate that the footbrake pedal is not depressed,
the output regulation unit being configured to prohibit regulation on the engine output when the switch failure detection unit determines that the first brake switch or the second brake switch has failed.

10. The vehicle according to claim 3, wherein the brake detection unit includes a first brake switch and a second brake switch for indicating whether the footbrake pedal is depressed or not, and
the vehicle further comprises a switch failure detection unit for determining that the first brake switch or the second brake switch has failed when the amount of depressing of the accelerator pedal detected by the accelerator detection unit is detected to be equal to or greater than a predetermined amount, the vehicle speed detected by the vehicle speed detection unit is equal to or greater than a predetermined vehicle speed, and the first brake switch or the second brake switch does not indicate that the footbrake pedal is not depressed,
the output regulation unit being configured to prohibit regulation on the engine output when the switch failure detection unit determines that the first brake switch or the second brake switch has failed.
